(19) United States
(12) Patent Application Publication
(10) Pub. No.: US 2026/0038997 A1
(43) Pub. Date: Feb. 5, 2026

(54) BATTERY CELL SEALING ASSEMBLY

(71) Applicant: Finding Fasteners Inc, Spring, TX (US)

(72) Inventors: Derek Crutchley, Warrington (GB); Tim Bartlett, Windsor (CA); Ryan Bostick, Spring, TX (US); Peter Thomas, Naugatuck, CT (US)

(21) Appl. No.: 18/885,299

(22) Filed: Sep. 13, 2024

Related U.S. Application Data
(60) Provisional application No. 63/539,136, filed on Sep. 19, 2023.

(51) Int. Cl. H01M 50/645; H01M 50/152; H01M 50/184; H01M 50/191; H01M 50/193

(52) U.S. Cl. CPC H01M 50/645; H01M 50/184; H01M 50/191; H01M 50/193; H01M 50/152; H01M 2220/20

(57) ABSTRACT

A sealing assembly for a battery cell cap having an access port is described. The sealing assembly includes a fastener with an enlarged head defining a cupped opening and the outside diameter of the enlarged head being greater than the diameter of the access port. The enlarged head is connected to an elongated body with an outside diameter being less than the diameter of the access port. The fastener is configured to be driven by a broaching member exerting a force on walls of the cupped opening within the enlarged head that causes an expansion of the outside diameter of the fastener to tightly engage and seal the access port of the battery cell cap.

### RELATED APPLICATION

The present application claims the benefit of U.S. Provisional Application No. 63/539,136 filed on Sep. 19, 2023, the entirety of which is incorporated by reference.

### FIELD

The present disclosure relates generally to battery devices, and in particular to a sealing assembly for a lithium-ion battery cell.

### BACKGROUND

Lithium-ion batteries have revolutionized the world of electric vehicles (EVs), propelling the automotive industry towards a cleaner and more sustainable future. These advanced energy storage devices have become the heartbeat of modern electric vehicles, powering them with efficiency, reliability, and impressive range. By harnessing the electrochemical properties of lithium ions, these batteries offer a high energy density, allowing EVs to travel longer distances on a single charge. The proliferation of lithium-ion batteries in electric vehicles not only addresses environmental concerns by reducing carbon emissions but also drives innovation in battery technology, charging infrastructure, and the overall EV ecosystem. The present disclosure is directed at improvements in the lithium-ion battery sealing assembly and methodology.

### BRIEF DESCRIPTION OF THE DRAWINGS

FIG. 1A, FIG. 1B, and FIG. 1C are illustrations of the lithium-ion battery used to store electrical energy in electrical vehicles (EVs);

FIG. 2 is a more detailed top view of a conventional cap with an access hole or fill port;

FIG. 3A and FIG. 3B show the top surface and bottom surface of a conventional cap with a sealing assembly installed to seal the center hole of the cap according to the teachings of the present disclosure;

FIG. 4 shows various methods using a broach pin mandrel (fixed and removable) along with a spherical expansion plug of the battery sealing assembly according to the teachings of the present disclosure;

FIG. 5 is a cross-sectional view of a one-piece fastener of the battery sealing assembly installed in the battery cell according to the teachings of the present disclosure;

FIG. 6 is a cross-sectional view that illustrates the installation of the one-piece fastener of the battery sealing assembly in the battery cell access port using a broaching member according to the teachings of the present disclosure;

FIG. 7 is a cross-sectional view that illustrates the installation of the fastener in the battery cell access port using an expansion pin according to the teachings of the present disclosure;

FIG. 8 is a cross-sectional view that illustrates the installation of the fastener 404 in the battery cell access port using a spherical expansion plug according to the teachings of the present disclosure;

FIG. 9 is a top view of the three different types of fastener of the battery sealing assembly shown in FIGS. 6-8 according to the teachings of the present disclosure;

FIG. 10 is a cross-sectional view that illustrates another embodiment of the battery cell sealing assembly incorporating a pliable sleeve according to the teachings of the present disclosure.

### DETAILED DESCRIPTION

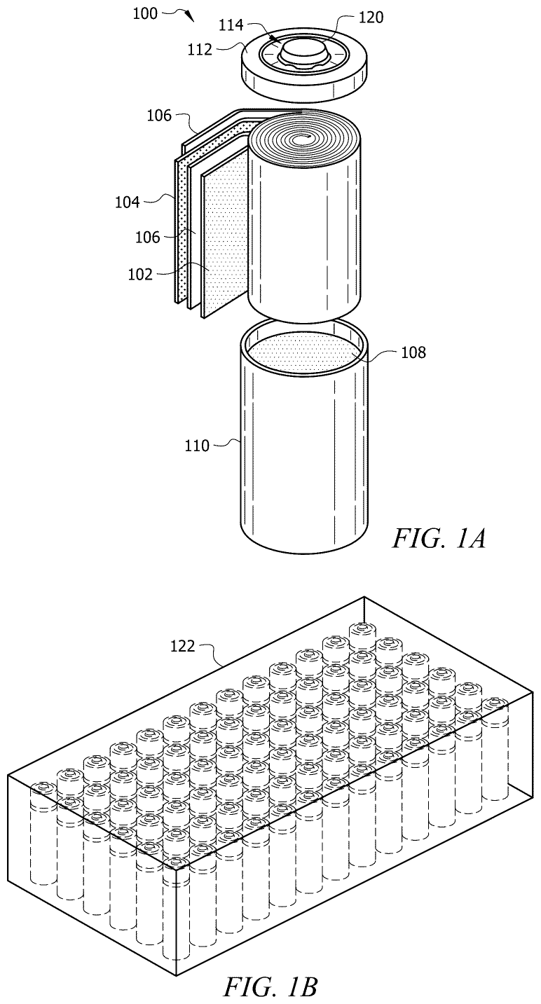

FIG. 1A is an illustration of the lithium-ion battery cell 100 used to store electrical energy in electrical vehicles (EVs). A lithium-ion battery cell 100 has several key components that include two electrodes, a cathode 102 and an anode 104, that are isolated from each other by separators 106, and an electrolyte solution 108 that are encased in a cylindrical battery casing 110. A cap or lid 112 with a small center opening or access port 114 is used to enclose one end of the battery casings. During assembly of the battery, the electrolyte solution is injected into the battery casing through the small opening (also called an access hole or fill port) 114 located at the center of the cap 112. This opening 114 then has to be sealed with a sealing assembly 120 to prevent the electrolyte fluid 108 from escaping the battery casing 110, and the sealing assembly 120 must remain intact with integrity for the service life of the battery cell 100. Multiple battery cells 100 may be packaged together to form a battery module 122, and multiple battery modules 122 are connected together to form a battery pack 124 that are integrated with the power system of an EV 126 (FIGS. 1B and 1C).

Conventional sealing methods for the battery cells include welding a metal plug in the opening using a pulsed laser. Other methods require the use of supplemental sealing materials such as a gasket or silicon to seal the fill port opening. The use of a sealant like silicon is undesirable as it can contaminate the electrolyte solution inside the battery. Another conventional method uses a mechanical pull stem blind rivet or a ball expansion. These conventional methods are slow and is error and defect prone. The present disclosure describes a new battery sealing assembly 120 that overcomes the shortcomings and functionality issues of conventional sealing methods. The battery sealing assembly 120 can be easily adapted for factory automation that would greatly increase the efficiency and throughput of the manufacturing process.

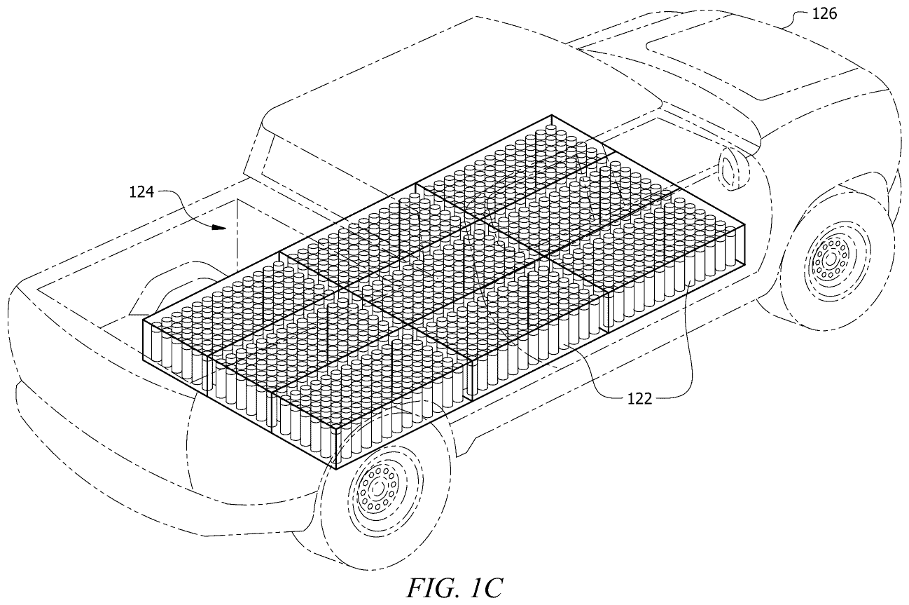

FIG. 2 is a more detailed top view of an example conventional cap 112 of a battery cell 100 or capacitor (not explicitly shown) with an access hole or fill port 114. As described above, the access port 114 is used to fill the battery cell with the electrolyte fluid that allows for ion conduction between the anode and cathode within the battery cell. The sealing assembly described herein is designed to be easily and quickly installed to close off the access port and maintain the seal for the life of the battery.

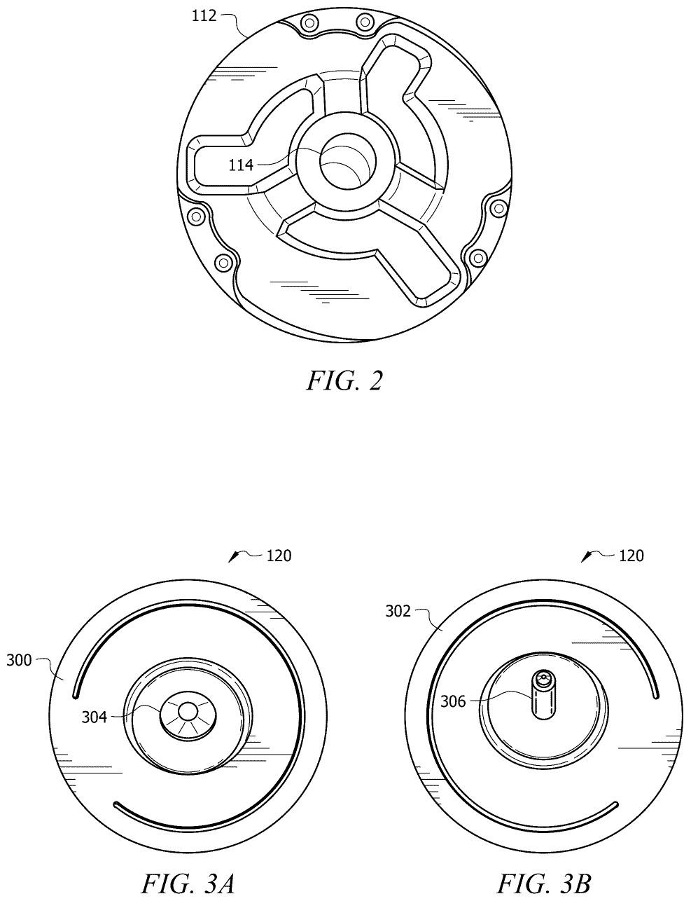

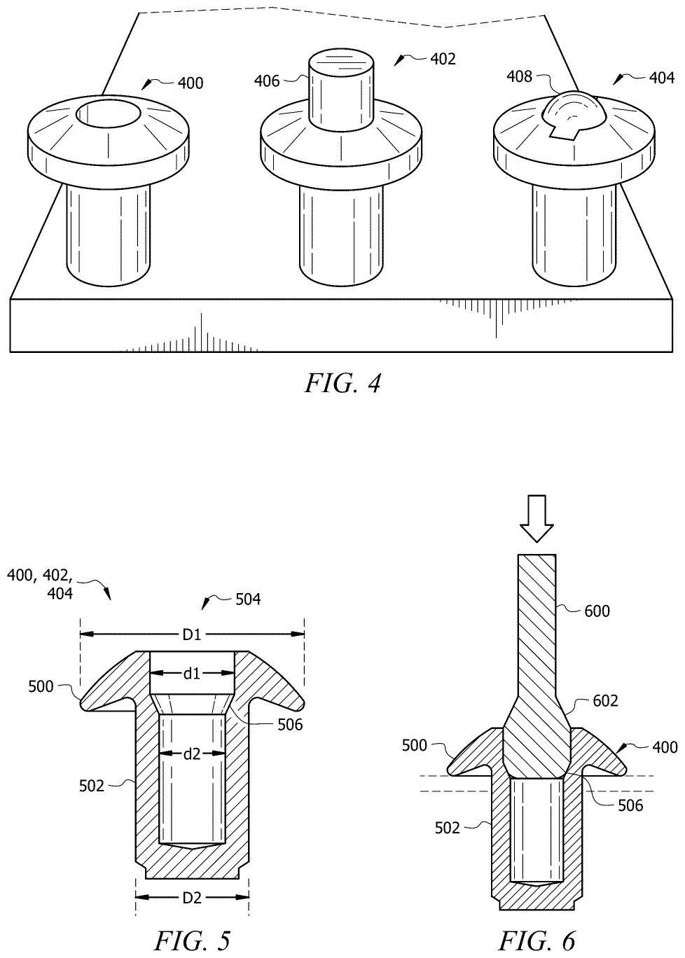

FIGS. 3A and 3B show the top surface 300 and bottom surface 302, respectively, of another example of a conventional battery cap 112 with a sealing assembly 120 installed to seal the center access port 114 of the cap 112 according to the teachings of the present disclosure. As shown in FIG. 3A, the enlarged head portion 304 of the sealing assembly 120 is shown firmly engaged within the access port 114. As shown in FIG. 3B, the shank portion 306 of the sealing assembly 120 protrudes beyond the bottom surface 302 of the cap 112. The use of a new mechanical battery sealing assembly 120 described herein avoids the slow and defect prone welding process used in conventional manufacturing processes. As shown in FIG. 4, three sealing assembly fastener options 400, 402, and 404 are available:
Option 1: A one-piece fastener 400 installed in the battery cell with a broaching tool;
Option 2: A fastener 402 with an expansion pin 406 inside that is driven in the battery cell with a broaching tool;
Option 3: A fastener 404 with a cup or standard fastener configuration with a spherical expansion plug 408 placed inside the cup that is driven in the battery cell with a broaching tool.

The broach tool or method include either a spherical expansion plug, a disposable push broach pin, or a reusable push broach pin. The use of the battery sealing assembly described herein to tightly engage and seal the battery cell access port or ports can be easily adapted to high-speed automation processes to increase production throughput.

FIG. 5 is a cross-sectional view of option 1 where the sealing assembly is a one-piece fastener 400 that has a head 500 coupled to a generally elongated hollow body 502. The general overall shape of the fastener 400 is similar to a slender cup with a solid bottom and a flared circular flange around the top lip of the cup forming the head 500. In one embodiment of the fastener 400, the head 500 is enlarged with a domed profile. The head 500 has an outside diameter D1 that is greater than the outside diameter D2 of the body 502. The fastener body diameter, D2, is less than the diameter of the access port in the battery cell cap so that the body portion 502 may be inserted through the access port opening. The head portion diameter, D1, is greater than the diameter of the battery cap access port so that the head portion 500 would sit on the top surface of the cap when the body 502 is inserted into the battery cell access port. The fastener 400 has a generally cylindrical opening 504 with an inside diameter d1 in the enlarge head portion 500 and a smaller inside diameter d2 in the body portion 502 (d1>d2). The larger inside diameter space is coupled to the smaller diameter space, forming a chamfered or cupped transition region 506 between the head portion 500 and the body portion 502.

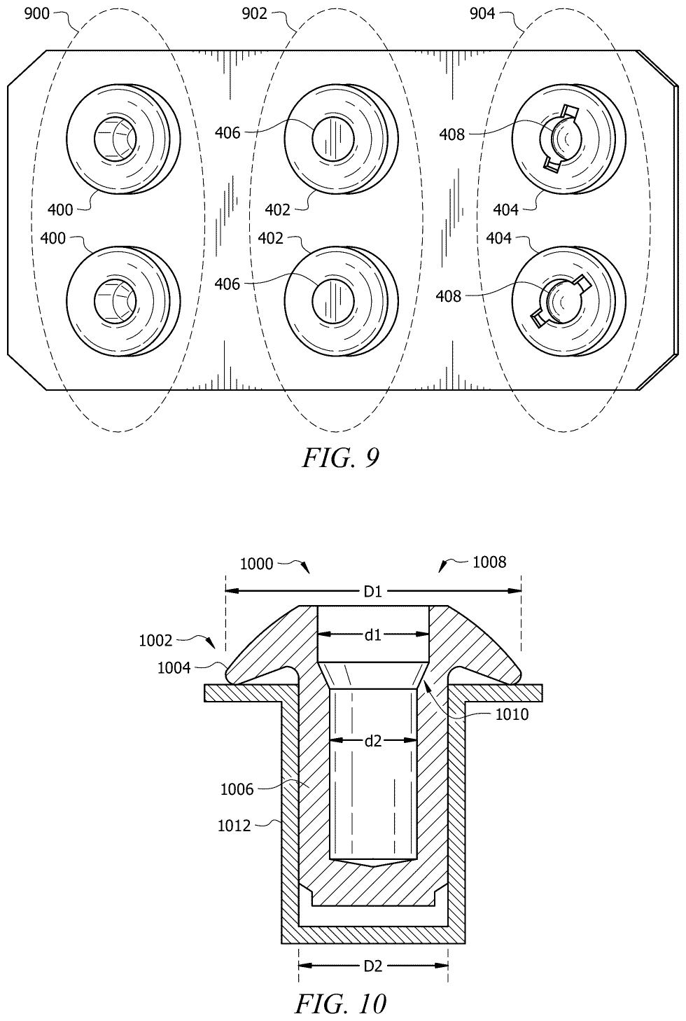

FIG. 6 illustrates the installation of the fastener 400 in the battery cell access port to seal the opening under option 1. The installation is done by using a broaching tool 600 with an enlarged mandrel head 602 (having a diameter that is greater than d2) that is pressed and pushed into the opening 504 of the fastener 400 with its elongated body 502 positioned in the access port. The force exerted by the mandrel head 602 against the cupped region 506 causes the fastener body to expand outward and wedge against the inner surface of the access port in the battery cell cap. Once the fastener 400 is firmly in place, the broaching tool is withdrawn. The installed fastener 400 would look like the examples 900 shown in FIG. 9 (shown without the battery cell cap).

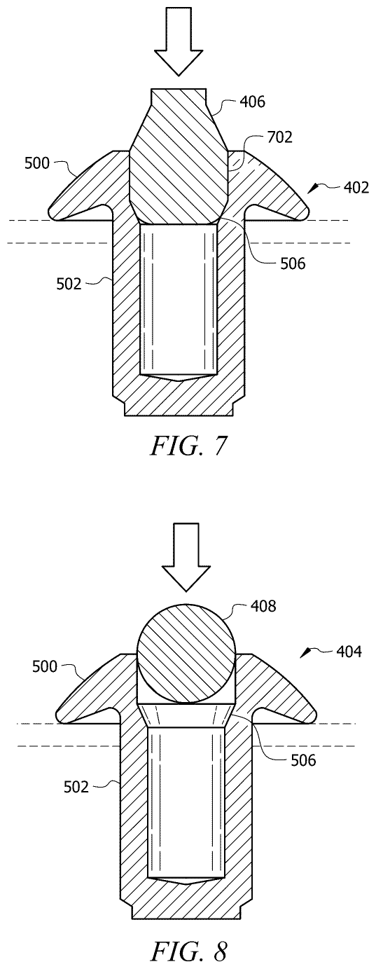

FIG. 7 illustrates the installation of the fastener 402 in the battery cell access port to seal the opening under option 2. The installation is done by forcing an expansion pin 406 with an enlarged head 702 (having a diameter that is greater than d2) into the opening 504 of the fastener 402 positioned in the access port. The force of the expansion pin 406 pushing against the cupped region 506 of the fastener causes the expansion pin 406 to press and cause the cupped region of the fastener body to expand outward against the inner surface of the access port in the battery cell cap. The expansion pin 406 is left in place and is fully contained within the space within the fastener body. The installed fastener 402 would look like the examples 902 shown in FIG. 9, where the expansion pin 406 is completely contained within the fastener 402 and flush with the top surface of the battery cell cap (shown without the battery cell cap).

FIG. 8 illustrates the installation of the fastener 404 in the battery cell access port to seal the opening under option 3. The installation is done by using a spherical expansion plug 408 (having a diameter that is greater than d2) that is pressed and pushed into the opening 504 of the fastener 404 with its elongated body 502 positioned in the access port. The force of the spherical expansion plug 408 pressed against the cupped region 506 of the fastener causes the spherical expansion plug 408 to cause the cupped region of the fastener body to expand outward to wedge against the inner surface of the access port of the battery cell cap. The spherical expansion plug 408 is fully driven into the fastener body and “staked” in place by using a specialized tool to create a mechanical “lock” by using the “staking” process to ensure 100% retention of the spherical expansion plug. The installed fastener 404 would look like the examples 904 shown in FIG. 9, where the spherical expansion plug 408 is completely contained within the fastener 404 (shown without the battery cell cap).

FIG. 10 is a cross-sectional view of a further embodiment of a sealing assembly 1000 with a fastener 1002 that has an enlarged head 1004 with an outside diameter D1 and a body 1006 with an outside diameter D2. A pliable sleeve 1012 which fully encases body 1006 of the fastener 1002 up to the underside of the enlarged head 1004. The fastener body diameter, D2, is less than the diameter of the access port in the battery cell cap so that the elongated body portion 1006 may be inserted through the access port opening. The diameter, D1, of the head portion 1004 is greater than the diameter of the battery cap access port so that the enlarged head 1004 would sit on the top surface of the cap. The fastener 1002 has a generally cylindrical longitudinal hollow space 1008 with an inside diameter d1 in the enlarge head portion 1004 and a smaller inside diameter d2 in the body portion 1006 (d1>d2). The larger inside diameter space of the head portion 1004 is coupled to the smaller diameter space of the body 1006, forming a chamfered or cupped transition region 1010 between the head portion 1004 and the body portion 1006. The sealing assembly 1000 further includes a pliable outer sleeve 1012 with a generally cylindrical shape that substantially envelope and contain the fastener body 1006. The sealing assembly 1000 can be installed in place by using any of the forgoing methods by using a broaching tool 600, expansion pin 406, or spherical expansion plug 408. The inclusion of the pliable sleeve provides a secondary seal between the battery cell cap access hole and the fastener 1002.

Accordingly, the present disclosure describes a battery cell access port sealing assembly that includes a fastener that can be quickly and easily installed using factory automation. The general assembly steps include these steps:
1. The battery cell (or capacitor) is positioned at a pre-determined and fixed location.
2. The fastener is presented and placed in the access port or fill hole of the battery cell cap. The fastener may include a spherical expansion plug.
3. Once placed in the battery cell cap (or capacitor) access port, the fastener is placed into the battery cell cap access port with any traditional assembly process, such as robotic pick-n-place, rotary index, gravity drop, etc. The physical locking of the fastener (to create the sealing effect) once placed in the lid or cap of the battery is conducted by means of a mechanical ram or pusher (with electrical, hydraulic, or air as a power source) using a broaching tool 600, expansion pin 406, or spherical expansion plug 408. The broaching tool 600 is part of the assembly equipment and retracted to be used for the next battery cell whereas the expansion pin 406 and spherical expansion plug 408 is left in place within the battery cell after assembly.

The assembly process is preferably controlled and monitored using computer and software (digital process monitoring) to ensure proper positioning, alignment, force, speed, and repeatability. In the case of the reusable broaching tool, the installation method will employ computer and software to monitor the wear of the reusable broaching tool over time. When unacceptable wear limits are encountered, the broaching tool will need to be replaced. Getting the fastener assembly properly positioned, aligned and placed within the battery cell is accomplished through traditional assembly machine methods.

It should be noted that the head portion of the fastener may have different profiles such as, for example, pan head, button head, wafer head, flat head, or domed head. Further, the head of the fastener may sit flush with the surface of the battery cell cap or it may protrude slightly beyond it. The cupped opening of the enlarged head may or may not be connected to the hollow space within the body. The fastener and/or expansion plug (expansion pin and spherical expansion plug) may be fabricated from any suitable metallic material, such as aluminum, steel, stainless steel, brass, Monel, titanium, and nickel. The pliable sleeve may be fabricated from any suitable plastic material, such as Polyethylene (PE), Polypropylene (PP), Polyvinyl Chloride (PVC), Polystyrene (PS), Polycarbonate (PC), Polyethylene Terephthalate (PET or PETE), Nylon (Polyamide, PA), and other suitable “plastic” materials.

The features of the present invention which are believed to be novel are set forth below with particularity in the appended claims. However, modifications, variations, and changes to the exemplary embodiments of the battery sealing assembly described above will be apparent to those skilled in the art, and the described herein thus encompasses such modifications, variations, and changes and are not limited to the specific embodiments described herein.

What is claimed is:

1. A sealing assembly for a battery cell cap having an access port, the sealing assembly comprising:
a fastener having an enlarged head defining a cupped opening and the enlarged head having an outside diameter greater than a diameter of the access port, the enlarged head being connected to an elongated body having an outside diameter being less than the diameter of the access port; and
the fastener being configured to be driven by a broaching member exerting a force on walls of the cupped opening within the enlarged head and causing an expansion of the outside diameter of the fastener to tightly engage and seal the access port of the battery cell cap.

2. The sealing assembly of claim 1, wherein the broaching member comprises a plug having a size dimensioned to fit inside the cupped opening of the enlarged head and being configured to expand against the cupped opening being driven by the broaching member.

3. The sealing assembly of claim 1, further comprising a plug having a size dimensioned to fit inside the cupped opening of the enlarged head and being configured to expand against the cupped opening being driven by the broaching member.

4. The sealing assembly of claim 1, further comprising a pliable sleeve substantially encasing the cylindrical hollow body and configured to form a secondary seal.

5. The sealing assembly of claim 3, further comprising a pliable sleeve substantially encasing about the elongated body.

6. The sealing assembly of claim 2, wherein the fastener and the plug are fabricated from a metallic material.

7. The sealing assembly of claim 4, wherein the pliable sleeve is fabricated from a plastic material.

8. The sealing assembly of claim 1, wherein the elongated body of the fastener is substantially hollow.

9. A sealing assembly for a circular fluid access port, the sealing assembly comprising:
a fastener having a generally cylindrical body with an enlarged head defining a cupped opening, the enlarged head having an outside diameter greater than a diameter of the access port, an outside diameter of the generally cylindrical body being less than the diameter of the access port;
a plug having a size dimensioned to fit inside the cupped opening of the enlarged head; and
the plug being configured to expand against the cupped opening being driven by a broaching member and causing an expansion of the outside diameter of the fastener to tightly engage and seal the access port.

10. The sealing assembly of claim 9, wherein the broaching member comprises the plug configured to expand against the cupped opening of the fastener.

11. The sealing assembly of claim 9, further comprising a pliable sleeve substantially encasing the cylindrical body and configured to form a secondary seal.

12. The sealing assembly of claim 9, wherein the fastener and the plug are fabricated from a metallic material.

13. The sealing assembly of claim 11, wherein the pliable sleeve is fabricated from a plastic material.

14. The sealing assembly of claim 9, wherein the enlarged head of the fastener is configured with a profile selected from the group consisting of a pan head, button head, wafer head, flat head, and domed head.

15. A method for sealing an electrolyte access port of an electrical component, the method comprising:
inserting an elongated body of a fastener into the access port, the fastener having an enlarged head coupled to the elongated body that remains outside of the access port;
forcing a broaching member into a cupped region defined in the enlarged head of the fastener, pressing walls of the cupped region of the fastener to expand outward against the access port and causing the fastener to tightly engage and seal the access port.

16. The method of claim 15, wherein forcing the broaching member into the cupped region comprises forcing a plug into the cupped region and causing the plug and the fastener walls to deform and tightly engage and seal the access port.

17. The method of claim 15, wherein forcing the broaching member into the cupped region comprises:
using a broaching tool to force a plug into the cupped region and causing the plug and the fastener walls to deform and tightly engage and seal the access port; and
retracting the broaching tool.

18. The method of claim 15, wherein forcing the broaching member into the cupped region comprises:
pushing a broaching pin into the cupped region and causing the broaching pin and the fastener walls to deform and tightly engage and seal the access port; and
allowing the broaching pin to remain within the cupped region.

19. The method of claim 15, wherein forcing the broaching member into the cupped region comprises:
using a broaching tool to force a spherical expansion plug into the cupped region and causing the spherical expansion plug and the fastener walls to deform and tightly engage and seal the access port; and
retracting the broaching tool and allowing the spherical expansion plug to remain within the cupped region.

20. The method of claim 15, wherein forcing the broaching member into the cupped region further comprises pressing walls of the cupped region of the fastener against a pliable sleeve encased about the elongated body forming a secondary seal to tightly engage and seal the access port.
